(19) United States
(12) Patent Application Publication
(10) Pub. No.: US 2019/0187310 A1
(43) Pub. Date: Jun. 20, 2019

(54) Subsalt Imaging Tool for Interpreters

(71) Applicant: Saudi Arabian Oil Company, Dhahran (SA)

(72) Inventors: Saleh Mohammed Al-Saleh, Dhahran (SA); Jianwu Jiao, Dhahran (SA); Ewenet Gashawbeza, Dhahran (SA); Ali Ameen Almomin, Dhahran (SA)

(21) Appl. No.: 15/843,871

(22) Filed: Dec. 15, 2017

(51) Int. Cl. G01V 1/28; G01V 1/34; G01V 1/30

(52) U.S. Cl. CPC G01V 1/282; G01V 1/345; G01V 2210/1212; G01V 2210/1295; G01V 1/303

(57) ABSTRACT

A subsalt imaging tool and seismic imaging process for complex geological environments such as subsalt structures having a rugged seafloor topology are provided. The subsalt imaging tool operates on stacked data as opposed to prestack data and uses a wave equation tomography to iteratively update a velocity model. Improved seismic images that improve the visibility of various events may be produced using the updated velocity model.

### BACKGROUND

### Field of the Disclosure

The present disclosure generally relates to geophysical subsurface seismic imaging in the field of geophysical seismic exploration. More specifically, embodiments of the disclosure relate to the seismic imaging of complex subsurface geological structures, such as rugged seafloor topographies having subsalt layers.

### Description of the Related Art

Subsalt exploration (that is, exploration below salt layers in geological structures) is difficult and complex due to the types of geological structures and high costs of drilling. In geophysical exploration, such as the exploration for hydrocarbons, seismic surveys are performed to produce images of the various rock formations in the earth and reduce exploration risk. In many instances, a seismic energy source can be used to generate seismic energy signals that propagate into the earth and are at least partially reflected by subsurface seismic reflectors such as interfaces between underground formations having different acoustic impedances. Such seismic energy reflections can subsequently be recorded in a geophysical time series by seismic energy detectors, sensors, or receivers positioned at a recording surface located at or near the surface of the earth, in a body of water, or at known depths in boreholes.

The resulting seismic data is processed and analyzed to yield information relating to produce seismic images of the formations and their locations in an area of interest beneath the earth's surface. Accurate seismic imaging relies on high fidelity imaging algorithms and accurate velocity models. Additionally, the production of accurate seismic images is lengthy and can be expensive. Subsalt layers introduce additional challenges in the production of accurate seismic images, and constructing earth models of the subsurface is difficult using conventional seismic imaging techniques. For example, thick salt layers may distort the seismic illumination of subsalt layers that contain potential hydrocarbon reservoirs. These challenges and difficulties further increase the exploration risk and cost in such complicated geological structures. Alternative approaches, such as the use of ray-based tomography to generate the velocity field, fail in most complex geological structures because the wavefield is distorted by lateral velocity variation caused by the complex geology.

### SUMMARY

Some techniques have attempted to address the challenges associated with the seismic imaging of complex geological structures having such as rugged seafloor topographies having subsalt layers. For example, as described in Saleh M. Al-Saleh et al., “Migration velocity analysis using traveltime wavefield tomography,” GEOPHYSICS, Volume 77, Issue 5 (September 2012), a migration velocity analysis may be performed using traveltime wavefield tomography. However, the domain for the migration velocity analysis is prestack data (that is the analysis is performed using prestack data). Such techniques that operate in the prestack data domain may use a sufficient amount of computational resource and may be cumbersome and less efficient for 3D datasets

In one embodiment, a method for producing a seismic image from seismic data generated from a plurality of seismic receiver stations configured to sense seismic signals originating from a plurality of seismic source stations is provided. The method includes obtaining the seismic data, the seismic data associated with a geological structure having a subsalt layer and determining a transmitted wavefield from the stacked data of the seismic data. The method also include iteratively updating a velocity model using the determined transmitted wavefield and a wave-equation tomography and producing a seismic image of the geological structure having the subsalt layer using the updated velocity model. IN some embodiments, the method includes processing the seismic data before determining a wavefield from the seismic image data. In some embodiments, the geological structure is a seafloor. In some embodiments, the method includes providing the seismic image to an interpreter. In some embodiments, determining the transmitted wavefield from the stacked data of the seismic data includes determining a Green's function from an analysis location to locations of the plurality of seismic receiver stations and shifting the Green's function by a time shift and convolving the shifted Green's function with a source function. In some embodiments, iteratively updating the velocity model includes inverting the determined transmitted wavefield using a traveltime inversion. In some embodiments, iteratively updating the velocity model includes using a steepest descent process to determine the updating.

In another embodiment, a non-transitory computer-readable storage medium having executable code stored thereon for producing a seismic image from seismic data generated from a plurality of seismic receiver stations configured to sense seismic signals originating from a plurality of seismic source stations is provided. The executable code includes a set of instructions that causes a processor to perform operations that include obtaining the seismic data, the seismic data associated with a geological structure having a subsalt layer and determining a transmitted wavefield from the stacked data of the seismic data. The operations also include iteratively updating a velocity model using the determined transmitted wavefield and a wave-equation tomography and producing a seismic image of the geological structure having the subsalt layer using the updated velocity model. In some embodiments, the operations include processing the seismic data before determining a wavefield from the seismic image data. In some embodiments, the geological structure is a seafloor. In some embodiments, the operations include providing the seismic image to an interpreter. In some embodiments, determining the transmitted wavefield from the stacked data of the seismic data includes determining a Green's function from an analysis location to locations of the plurality of seismic receiver stations and shifting the Green's function by a time shift and convolving the shifted Green's function with a source function. In some embodiments, iteratively updating the velocity model includes inverting the determined transmitted wavefield using a traveltime inversion. In some embodiments, iteratively updating the velocity model includes using a steepest descent process to determine the updating.

In another embodiment, a system for producing for producing a seismic image from seismic data associated with a geological structure having a subsalt layer is provided. The system includes a plurality of seismic source stations, a plurality of seismic receiver stations configured to sense seismic signals originating from the plurality of seismic source stations and generate the seismic data, and a seismic data processor. The system also includes a non-transitory computer-readable storage memory accessible by the seismic data processor and having executable code stored thereon for producing the seismic image from the seismic data. The executable code comprising a set of instructions that causes the seismic data processor to perform operations that include obtaining the seismic data, the seismic data associated with a geological structure having a subsalt layer and determining a transmitted wavefield from the stacked data of the seismic data. The operations also include iteratively updating a velocity model using the determined transmitted wavefield and a wave-equation tomography and producing a seismic image of the geological structure having the subsalt layer using the updated velocity model. In some embodiments, the operations include processing the seismic data before determining a wavefield from the seismic image data. In some embodiments, the geological structure is a seafloor. In some embodiments, the operations include providing the seismic image to an interpreter. In some embodiments, determining the transmitted wavefield from the stacked data of the seismic data includes determining a Green's function from an analysis location to locations of the plurality of seismic receiver stations and shifting the Green's function by a time shift and convolving the shifted Green's function with a source function. In some embodiments, iteratively updating the velocity model includes inverting the determined transmitted wavefield using a traveltime inversion. In some embodiments, iteratively updating the velocity model includes using a steepest descent process to determine the updating.

### BRIEF DESCRIPTION OF THE DRAWINGS

FIG. 1 is schematic diagram of depicts a system for producing a seismic image using a subsalt imaging tool in accordance with an embodiment of the disclosure;

FIG. 2 is a flowchart of a seismic imaging process using a subsalt imaging tool in accordance with an embodiment of the disclosure;

FIG. 3 a flowchart of the operations of a subsalt imaging tool in accordance with an embodiment of the disclosure;

FIGS. 4 and 5 depict examples of seismic images produced before and after application of a subsalt imaging tool in accordance with an embodiment of the disclosure; and

FIG. 6 is a block diagram of a seismic data processing computer having a subsalt imaging tool in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure are directed to the seismic imaging of complex geological environments such as subsalt structures having a rugged seafloor topology. Embodiments includes systems and processing that include a subsalt imaging tool that operates in the stacked data domain (that is, on stacked data) as opposed to conventional prior art techniques that operated in the prestack data domain. The subsalt imaging tool includes an integrated wave-equation technique for migration velocity analysis (MVA) that uses a wave equation tomography scheme to update the velocity model in the presence of the large velocity errors associated with complex geological environments. The subsalt imaging tool using the wave equation tomography scheme operates in the stacked data domain (that is, on stacked data), as opposed to the prestack data domain. Seismic images may be produced using the updated velocity model. A seismic imaging process is also described in the disclosure and may include the acquisition and processing of seismic data and use of the subsalt imaging tool to produce seismic images.

Advantageously, embodiments of the disclosure provide increase the accuracy of subsurface velocity models and improve seismic imaging for complex geological structures, especially those structures having subsalt layers. Further, embodiments of the disclosure enable seismic interpreters to work directly with seismic data, resulting in an increase in efficiency of seismic imaging and construction of velocity models. Moreover embodiments of the disclosure may provide for more efficient seismic imaging for complex geological structures, as the seismic imaging process uses less computing resources than conventional MVA techniques that operate in the prestack data domain and that are cumbersome and less efficient for 3D datasets. For example, in some embodiments, embodiments of the disclosure that use stack data instead of prestack data may reduce the computational resources used by an sufficient to enable the seismic image to be generated using a single computer as opposed to a computing cluster (that is, multiple connected computers required to provide a minimum amount of computing resources).

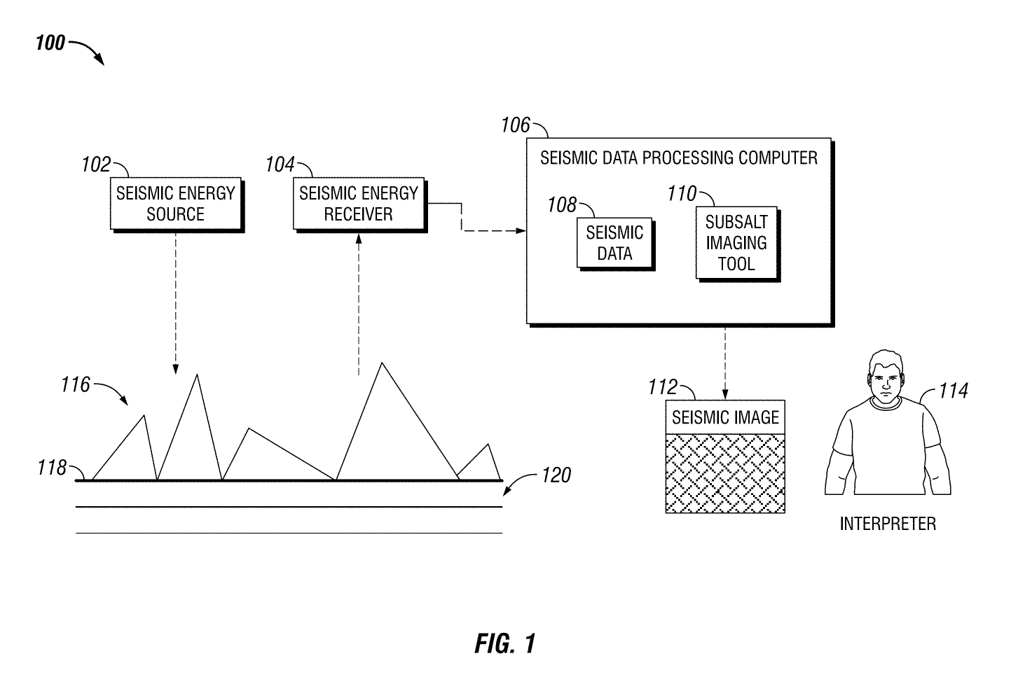

FIG. 1 depicts a system 100 for producing a seismic image using a subsalt imaging tool in accordance with an embodiment of the disclosure. More particularly, FIG. 1 illustrates a high-level, schematic, block flow diagram overview of the example system 100 for generating seismic data and producing a seismic image from such data using a subsalt imaging tool. The system 100 can include, for example, a seismic energy source 102, a seismic energy receiver 104, a seismic data processing apparatus 106 that produces seismic image data 108 such as a shot gather or a seismic stack responsive to seismic energy signals received by the seismic energy receiver, a subsalt imaging tool 110 that produces a seismic image 112 from stacked seismic data, and an interpreter 114. According to various embodiments of the present disclosure, the seismic energy source 102 can include any seismic or acoustic energy whether from an explosive, implosive, swept-frequency or random sources. The seismic energy source, for example, can generate a seismic energy signal that propagates into the earth 116. As illustrated in FIG. 1, the earth 116 can, for example, take the form of complex geology or topography having, for example, a base salt layer 118 and one or more subsalt layers 120.

Generally, the seismic energy source 102 can emit seismic waves into the earth 116 to evaluate subsurface conditions and to detect possible concentrations of oil, gas, and other subsurface minerals. Seismic waves may travel through an elastic body (such as the earth 116). The propagation velocity of seismic waves can depends on the particular elastic medium through which the waves travel, particularly the density and elasticity of the medium as is known and understood by those skilled in the art. For instance, the propagation velocity of seismic waves can range from approximately three to eight (3-8) kilometers per second (km/s) in the earth's 80 crust to up to thirteen (13) kilometers per second (km/s) in the earth's 80 deep mantle. Generally, in the field of geophysics, as is known and understood by those skilled in the art, the refraction or reflection of seismic waves onto a seismic energy receiver 104 can be used to research and investigate subsurface structures of the earth 116.

Accordingly, the seismic energy receiver 104 can be positioned to receive and record seismic energy data or seismic field records in any form including, but not limited to, a geophysical time series recording of the acoustic reflection and refraction of waveforms that travel from the seismic energy source 102 to the seismic energy receiver 104. Variations in the travel times of reflection and refraction events in one or more field records in seismic data processing can produce seismic data 108 that demonstrates subsurface structures according to the techniques described herein. Beneficially, seismic images produced from the seismic image data may be used to aid in the search for, and exploitation of, subsurface mineral deposits in the geological structure.

Generally speaking, seismic image receivers 104 can record sound wave echoes (otherwise known as seismic energy signal reflections) that come back up through the ground from a seismic energy source 102 to a recording surface. Such seismic image receivers 104 can record the intensity of such sound waves and the time it took for the sound wave to travel from the seismic energy source 102 back to the seismic energy receiver 104 at the recording surface. According to various exemplary embodiments of the present disclosure, for example, during the seismic imaging process, the reflections of sound waves emitted by a seismic energy source 102, and recorded by a seismic energy recording 104, can be processed by a computer to generate a seismic image, of the subsurface. The seismic image of the subsurface can be used to identify, for example, the placement of wells and potential well flow paths.

More specifically, the term seismic energy receiver 104 as is known and understood by those skilled in the art, can include geophones, hydrophones and other sensors designed to receive and record seismic energy. A geophone, generally speaking, is a seismic energy receiver which converts ground movement (or displacement of the ground) into voltage which may be recorded at a recording station. A deviation of the measured voltage from a base line measured voltage produces a seismic response which can be analyzed and processed by a computer to produce an unfiltered seismic image of subsurface geophysical structures. Accordingly, by placing a plurality of geophone seismic energy receivers 104 at a recording surface, a two-dimensional seismic image can be produced responsive to voltage difference data collected by the geophone seismic energy receivers 104. Hydrophones, as are known and understood by those skilled in the art, are another type of seismic energy receiver designed specifically for underwater recording or listening to underwater sound. Such hydrophones may include a piezoelectric transducer, as is known and understood by those skilled in the art, which generates electricity when subjected to a pressure change. Piezoelectric transducers can, accordingly, covert a seismic energy signal into an electric signal since seismic energy signals are a pressure wave in fluids.

According to an embodiment of the present disclosure, a seismic energy receiver 104 can be positioned to receive and record seismic energy data or seismic field records in any form including a geophysical time series recording of the acoustic reflection and refraction of waveforms that travel from the seismic energy source 102 to the seismic energy receiver 104. Variations in the travel times of reflection and refraction events in one or more field records in a plurality of seismic signals can, when processed by the seismic data processing computer 106, produce seismic data 108 that demonstrates subsurface structures. As described herein, prior to using a seismic data 108 to aid in the search for, and exploitation of, mineral deposits, the seismic image 112 may be generated using the subsalt imaging tool 110 to produce an improved seismic image for use by the interpreter 114. The interpretation of the seismic image 112 may be used to determine the location of wells drilling into the earth 116. Thus, one or more drills may be drilled into the earth 116 in response to the generation and interpretation of the seismic image 112.

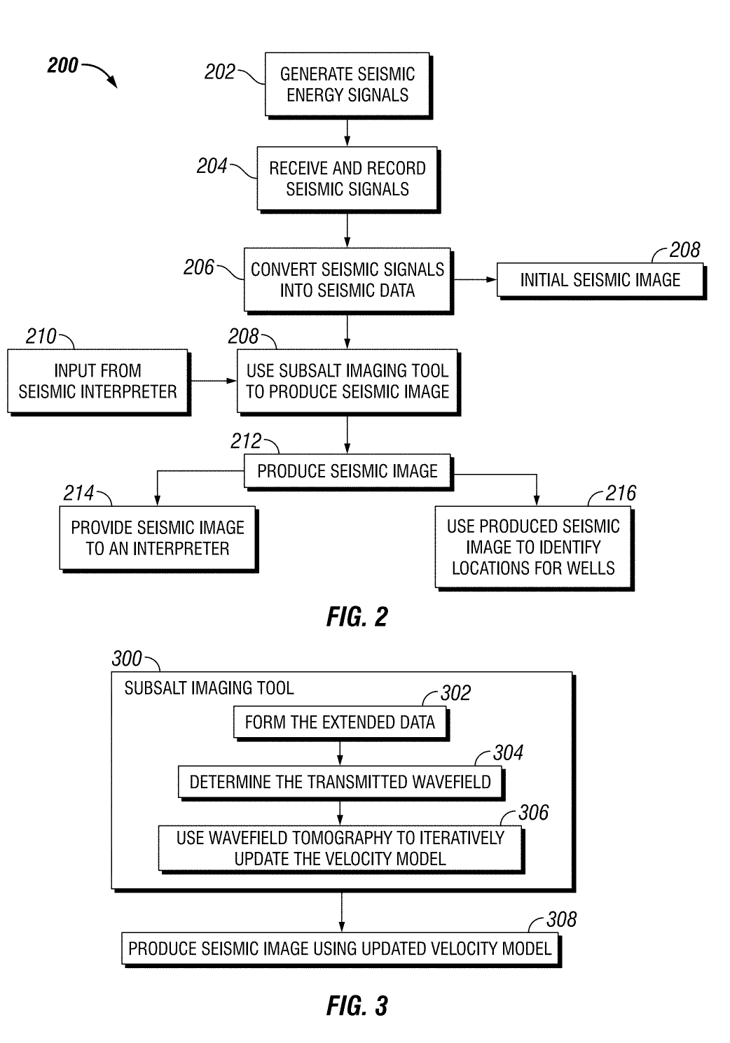

FIG. 2 depicts a seismic imaging process 200 using a subsalt imaging tool 202 in accordance with an embodiment of the disclosure. Initially, as shown in FIG. 2, seismic energy signals may be generated using a seismic energy source that propagates into the earth and is at least partially reflected by subsurface seismic reflectors as is known and understood in the by those of ordinary skill in the art (block 202). The reflections and refractions of the seismic energy signals may be received and recorded using a seismic energy receiver as discussed above (block 204). The reflections and refractions of the seismic energy signals may be converted into seismic data (block 206). In some embodiments, an initial seismic image may be generated from the seismic image data using known techniques (block 208). However, as discussed further herein, the seismic images generated from seismic data using prior art techniques (for example, using conventional MVAs that operate in the prestack data domain) may be distorted due to the salt and subsalt layers and may be computationally expensive (that is, may require a large amounts of time and computational resources).

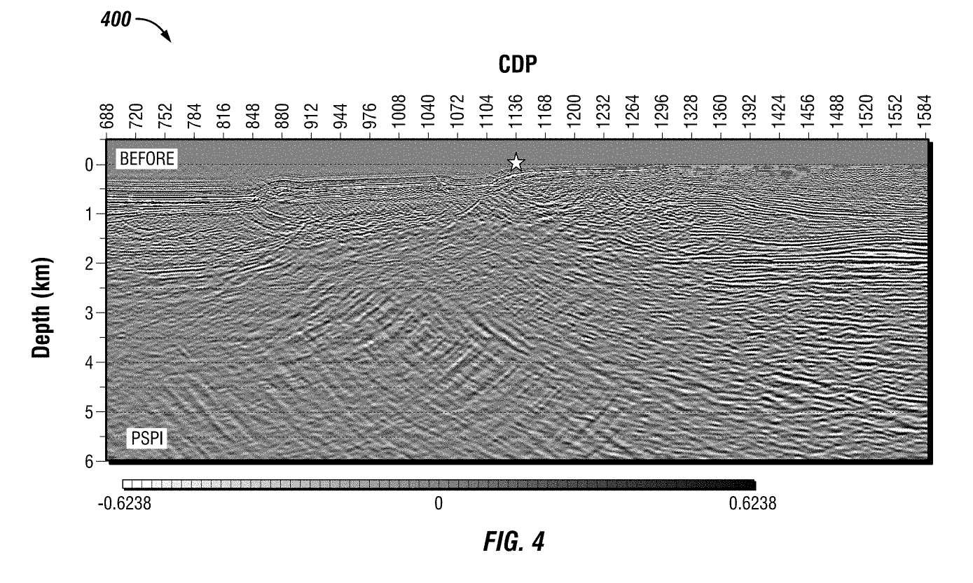

The seismic imaging process 200 may then include using a subsalt imaging tool to produce an improved seismic image from the seismic image data (block 208) by operating on the stacked data from the seismic image data. The subsalt imaging tool is illustrated in FIG. 3 and described further below. In some embodiments, as also described below, the subsalt imaging tool may receive input from a seismic interpreter (block 210).

The subsalt imaging tool 202 may produce a seismic image 212 using the velocity model determined by the subsalt imaging tool, as opposed to the velocity model used to produce the initial seismic image 208. The produced seismic image may be provided to an interpreter (block 214). For example, the produced seismic image may be displayed on a display of a computer accessible by the interpreter, or transmitted over a network to a computer accessible by an interpreter. The improved seismic image 212 may enable better identification of features and areas of interest in complex geological environments such as subsalt structures. For example, the produced seismic image 212 may be used to identify locations in complex geological environments for well drilling (block 216). The produced

FIG. 3 is a block diagram of the operations of a subsalt imaging tool 300 in accordance with an embodiment of the disclosure. As described below, the MVA of the subsalt imaging tool 300 is performed in the stacked data domain as a function of nonzero cross correlation lags. Initially, the subsalt imaging tool 300 may form the extended data from the seismic data (block 302). All wavefield simulations are assumed to satisfy the constant density acoustic wave-equation shown in Equation 1:

$$( {∇}^{2} - m ( x ) \frac{{\partial }^{2}}{\partial {t}^{2}} ) U ( x , t ; {x}_{s} ) = f ( t ; {x}_{s} ) \qquad ( 1 )$$

Where x=[x, y, z] represents the spatial coordinates, xₛ=[xₛ, yₛ, zₛ] represents the source location (shot axis), m represents the slowness squared velocity model, t represents time, U represents the simulated receiver wavefield to all x, and f is the source function. The extended data may be formed by generating the stacked image I by summing over the shot axis xₛ, generating all the migrated shot gathers using reverse time migration (RTM) as known by in the art, and retaining the correlation lags r, as shown in Equation 2:

I(x,τ)=Σₓ_{ₛ}∫ₜψ(x,t−τ;Xₛ)U(x,t+τ;xₛ)dt (2)

Where ψ represents the simulation source wavefield to all x, U represents the simulated receiver wavefield to all x, and τ is the cross-correlation shift (also referred to as the cross-correlation lag). The focusing depth and cross-correlation lag, τ_{f} and z_{f} for an event i are determined when the image stacked section, I, has the maximum stack response over a window of stacked N traces. The parameter, N, is an arbitrary number that may be selected based on the complexity of the surface. As will be appreciated, the value of N may depend on the complexity of the subsurface: a large value for N may be sufficient for a smooth medium and a small value of N may be sufficient for a complex medium. In addition, the maximum stack response can be defined as the section having the best continuity, highest amplitude response, or geological basis. In some embodiments, these criteria may be selected by a user of the subsalt imaging tool (for example, a seismic interpreter, as shown in block 210 of FIG. 2). The stacked data described in Equation 3 is used in the determination of an updated velocity model as further described below.

Next, the transmitted wavefield may be determined (block 304). The background model used the migration, m_{b}(x), may be a reasonable approximation of the correct velocity, such that m_{b}(x)≈mₜ(x), if z_{b}≈zₜ≈z_{f} and τ_{f}≈0, where zₜ is the imaged depth using the correct velocity model and z_{b} is the imaged depth with the background velocity model. Conversely, the background model is not a good approximation of the correct model, when z_{b}≠zₜ≠z_{f} and τ_{f}≠0. As will be appreciated, the stacked response of an event for a window, N, depends on the accuracy of m(x). If the maximum stacked response for an event with N traces occurs close to the zero-lag, then the velocity model is accurate at this window for this event. If the maximum stacked response for an event with N traces occurs at a nonzero lag, then the velocity field is updated. For updating the velocity model, the focusing time and depth, τ_{f} and z_{f}, are picked for each event over each window of N traces.

The determination of the transmitted wavefield includes modeling the wavefield for each analysis location x_{f}_{₀}=(x₀, y₀, z_{f}), where [x₀, y₀] represents the lateral coordinates at trace N/2+1 of each window for an event. The Green's function of the one-way wave equation may be calculated from the analysis location x_{f}_{₀} to the receivers at x_{g}, where x_{g}=[x_{g}, y_{g}, z_{g}] representing the receiver location, such that the Green's function is determined by Equation 3:

G(x_{g},t;x_{f}_{₀}) (3)

As will be appreciated, x_{g} may be determined by receivers within the N window.

The modeled response is then shifted by τ_{f}/2, then convolved with the source function f(t) to obtain the transmitted wavefield, shown in Equation 4:

$$U ( {x}_{{f}_{0}} , {x}_{g} , t ) = f ( t ) \times G ( {x}_{g} , t - \frac{τ}{2} ; {x}_{{f}_{0}} ) \qquad ( 4 )$$

Where x is a convolution operator. After shifting the modeled wavefield with the time-shift τ_{f}/2, the new depth of the source is unknown. The transmitted wavefield U is assumed to approximate the observed wavefield that would have been produced with the correct model. Using the assumption, an observed wavefield may be produced even with an incorrect model. As will be appreciated, at the correct focusing depth, the downward continued recorded data and forward modeled sources for a subsurface location are separated by a time-shift with a weak dependency on surface offset (that is, source distance from the analysis location). Thus, applying a time-shift τ_{f}/2 to events in the extrapolated source and receiver wavefields, in opposite directions, will produce similar wavefields for both, at least at certain offsets. Cross-correlating the source and receiver wavefields after updating with τ_{f}/2 produces a flat event without knowing the correct depth. Thus, the techniques discussed above result in the synthesis of data for determining the transmitted wavefield. As will be appreciated, flat events on the zero-lag gather, for an isotropic medium, indicates that the background velocity model used for the migration is acceptable. Such a flatness criterion may be used in MVA, but a flat event does not always indicate that the correct velocity model was used due to the non-uniqueness of the building of velocity model. The operations of the subsalt imaging tool described herein use the flatness criterion, so a flat event in the stacked image will result from cross-correlating events with similar travel times in the source and receiver domains. The subsalt imaging tool can thus simulate this data without knowing the correct model and using wavefield tomography to determine this information. The modeled and shifted wavefield is thus used as the correct transmitted wavefield. The determined transmitted wavefield may have less noise than the real data and enables easier analysis.

Next, the wavefield tomography is used to update the velocity model (block 306). The transmitted wavefield is inverted using a traveltime inversion scheme. The traveltime inversion scheme used is a modification of a traveltime inversion scheme that uses the isotropic two-way wave equation. The traveltime inversion scheme is modified to invert for one-way operators using a specific geometry where the source location is deep in the subsurface and overlaid by receivers. The wave equation tomography is modified to apply the MVA to the stack domain used for a seismic interpretation.

The iterative updating scheme is shown in Equation 5:

mⁿ⁺¹=mⁿ+Δmⁿ (5)

Where Δmⁿ is expressed as shown in Equation 6:

Δmⁿ=−μⁿ∇J(mⁿ) (6)

Where n>0 is the iteration number, μ is the step length, and mⁿ⁼¹=m_{b} (that is, the initial model is the background slowness squared model). In some embodiments, the steepest descent technique of computing the update is used. In other embodiments, other techniques may be used, such as the conjugate gradient, the Newton algorithm, of the Gauss-Newton algorithms. The model update Δm, for a particular iteration n, is found by scaling the steepest descent direction of the objective function with a step length μ. The objective function is defined as shown in Equation 7:

J(m)=1/2Σₓ_{_{c}}Σₓ_{_{g}}∥Δτ(x_{c},X_{g};m)∥₂² (7)

where ∥ ∥₂² is the least squares norm, and the gradient is the sum over different lateral positions such that x_{c}=[x₀, z_{c}], where z_{c} is the source depth that falls with the range shown in Equation 8:

$${z}_{c} ∈ \{ \begin{matrix}[ {z}_{f} , {z}_{b} ] , {τ}_{f} < 0 \\ [ {z}_{b} , {z}_{f} ] , {τ}_{f} > 0\end{matrix} \} \qquad ( 8 )$$

The shift Δτ is picked from the cross-correlation function expressed by Equation 9:

C(x_{c},x_{g},τ)=∫ₜφ(x_{c},x_{g},t−τ)U(x₀,x_{g},t)dt (9)

Where U(x₀, x_{g}, t) is the determined transmitted wavefield and φ(x_{c}, x_{g}, t) is the calculated wavefield modeled by seeding a delta function at x_{c}=(x₀, z_{c}) in a similar manner to U(x₀, x_{g}, t). The cross-correlation shift Δτ(x_{c},x_{g}) is picked for each z_{c} as the local maxima according to Equation 10:

C(x_{c},x_{g},Δτ)=max C(x_{c},x_{g},τ) (10)

The derivative of C with respect to τ at τ=Δτ is zero. The gradient used to compute Δm is determined according to Equation 11:

$$∇ J ( m ) = {\sum }_{{x}_{c}} {\sum }_{{x}_{g}} \frac{\partial Δτ ( {x}_{c} , {x}_{g} ; m )}{\partial m} Δτ ( {x}_{c} , {x}_{g} ; m ) \qquad ( 11 )$$

Using the rule for differentiating functions, Equation 12 may be determined:

$$\frac{\partial Δ τ ( {x}_{c} , {x}_{g} ; m )}{\partial m} = - \frac{\partial \dot{C}}{\partial m} / \frac{\partial \dot{C}}{\partial Δ τ} = \frac{1}{E} {\int }_{t} \\ \dot{U} ( {x}_{0} , {x}_{g} , t + Δτ ) \frac{\partial ϕ ( {x}_{c} , {x}_{g} , τ )}{\partial m} dt \qquad ( 12 )$$

Where E is expressed according to Equation 13:

E=−∫ₜÜ(x₀,x_{g},t+Δτ)φ(x_{c},x_{g},τ)dt=−∫ₜ\dot{U}(x₀,x_{g},t+Δτ)φ(x_{c},x_{g},τ)dt (13)

And ∂φ/∂m is the derivative operator evaluating wavefield perturbations around the background wavefield that may be caused by model perturbations Δm against the background model m. The derivate operator using a Born approximation may be expressed according to Equation 14:

$$\frac{\partial ϕ ( {x}_{c} , {x}_{g} , τ )}{\partial m} = [ \dot{G} ( {x}_{g} , x , t ) \times ψ ( {x}_{c} , {x}_{t} ) ] \qquad ( 14 )$$

where x indicates the convolution operation where the forward modeled source to all x may be obtained using Equation 15:

ψ(x_{c},x,t)=f(t)×Ġ(ψ(x_{c},x,t) (15)

Equation 15 may be used to rewrite ∂Δτ/∂m as Equation 16:

$$\frac{\partial Δτ ( {x}_{c} , {x}_{g} ; m )}{\partial m} \frac{1}{E} {\int }_{t} \dot{G} ( {x}_{g} , x , t ) \times ψ ( {x}_{c} , x , t ) \dot{U} ( {x}_{0} , {x}_{g} , t + Δτ ) dt \qquad ( 16 )$$

The identities shown in Equation 17 may be used to rewrite ∂Δτ/∂m as Equation 18:

$$\begin{matrix} {\int }_{t} h ( t ) ( g ( t ) \times r ( t ) ) dt = {\int }_{t} r ( t ) ( g ( - t ) \times h ( t ) ) dt & ( 17 ) \\ \frac{\partial Δτ ( {x}_{c} , {x}_{g} ; m )}{\partial m} = \frac{1}{E} {\int }_{t} \dot{G} ( {x}_{g} , x , - t ) \cdot \dot{U} ( {x}_{0} , {x}_{g} , t + Δ τ ) \dot{ψ} ( {x}_{c} , x , t ) dt & ( 18 )\end{matrix}$$

Using Equation 18, the gradient may be expressed according to Equation 19, with (x_{c},x_{g};m) dropped from Δτ for clarity:

$$∇ J ( m ) = \frac{1}{E} {\sum }_{{x}_{c}} {\sum }_{{x}_{g}} \dot{G} ( {x}_{g} , x , - t ) \cdot \dot{U} ( {x}_{0} , {x}_{g} , t + Δτ ) \dot{ψ} ( {x}_{c} , x , t ) dt \qquad ( 19 )$$

The equations above show that the gradient function is obtained by taking the zero-lag of the cross-correlation between the forward modeled wavefield and downward continued wavefield to all x, where both are scaled by 1/E and Δτ.

The correct depth of a particular event is approximated by modeling the sources from different depths to find the source wavefield ψ, that minimizes the objective function and assuming that the correct depth falls within a range of depths. The depth range may be determined based on the focusing depth and lag information. For example, in a constant velocity medium, a positive τ_{f} indicates that the velocity used for migration was too fast, and a negative τ_{f} indicates that the migration velocity field was too slow. This means that for τ_{f}<0, z_{f}<zₜ<z_{b} and for τ_{f}>0, z_{f}<zₜ<z_{b}, such that z_{f}, zₜ, and z_{b} are the focusing, correct, and background depths respectively. In such embodiments, all possible depths of z_{c} may be scanned to find zₜ (an approximation to the correct depth) using the formula shown in Equation 20:

J(m;zₜ)=min{J(m;z_{c})} (20)

where z_{c} is expressed as follows in Equation 21:

$${z}_{c} ∈ \{ \begin{matrix}[ {z}_{f} , {z}_{b} ] , τ < 0 \\ [ {z}_{f} , {z}_{b} ] , τ > 0\end{matrix} \} \qquad ( 21 )$$

In view of the above discussion, selecting the optimal depth of a particular event of horizon may be performed by determining the gradient of each objective function, scaling the gradient function to get a model update, modelling a new wavefield, cross-correlating the new wavefield with the observed wavefield, and then determining a new objective function. The optimal depth may be determined as the depth that provides the smallest objective function. Implementing this process in a layer stripping fashion may be used to approximate the correct depth.

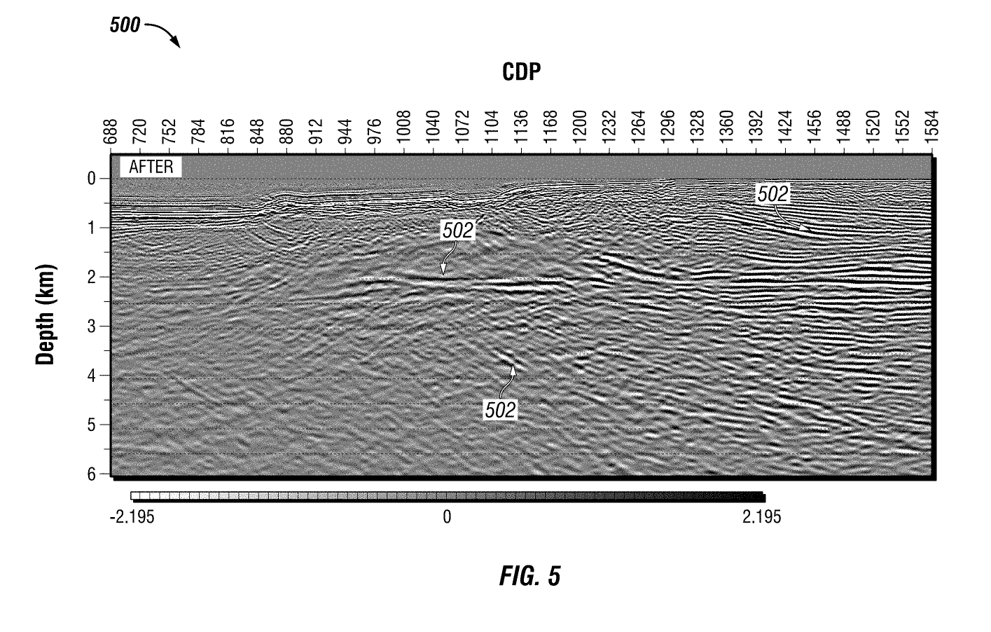

FIGS. 4 and 5 depict examples of seismic images produced before and after application of the subsalt imaging tool described herein in accordance with an embodiment of the disclosure. FIG. 4 depicts a “before” seismic image 400 produced using seismic image data processing techniques known in the art and without application of the subsalt imaging tool described herein. FIG. 5 depicts an “after” seismic image 500 produced using a subsalt imaging tool, such as the subsalt imaging tool described in FIG. 3 and discussed above. As indicated by arrows 502, the seismic image 500 produced using the subsalt imaging tool results in improved visibility of base salt and other events in the seismic image as compared to the “before” image produced without the subsalt imaging tool. The updated velocity model producing using the iterative updating scheme described in Equations 5 and 6 and the techniques discussed above may be used to produce a seismic image such as the example seismic image 500.

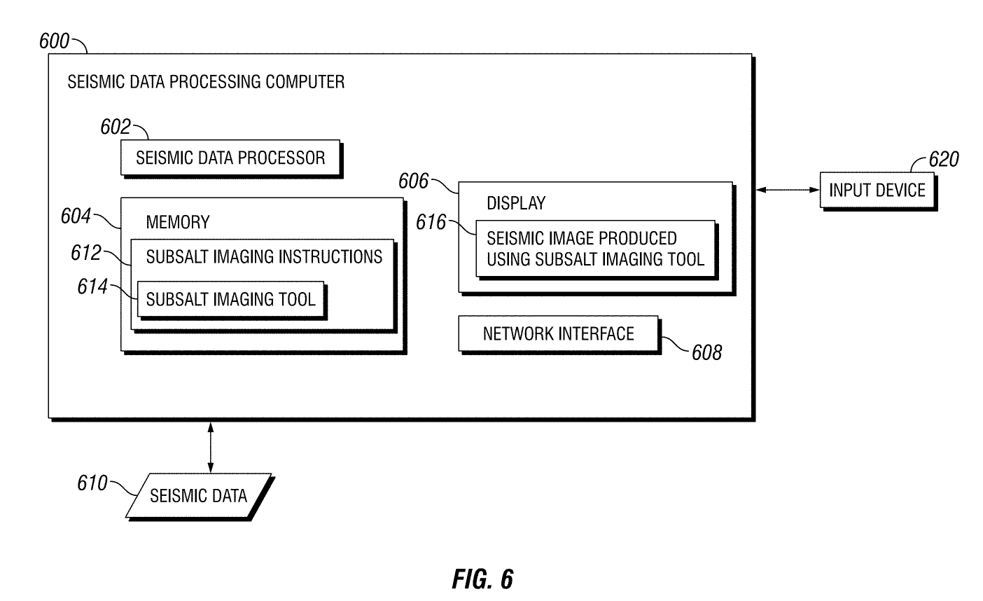

FIG. 6 depicts components of a seismic data processing computer 600 in accordance with an embodiment of the disclosure. In some embodiments, seismic data processing computer 600 may be in communication with other components of a system for obtaining and producing seismic data. Such other components may include, for example, seismic shot stations (sources) and seismic receiving stations (receivers). As shown in FIG. 6, the seismic data processing computer 600 may include a seismic data processor 602, a memory 604, a display 606, and a network interface 608. It should be appreciated that the seismic data processing computer 600 may include other components that are omitted for clarity. In some embodiments, seismic data processing computer 600 may include or be a part of a computer cluster, cloud-computing system, a data center, a server rack or other server enclosure, a server, a virtual server, a desktop computer, a laptop computer, a tablet computer, or the like. However, as noted above, embodiments of the disclosure that use stack data instead of prestack data may reduce the computational resources used by an sufficient to enable the seismic image to be generated using a single computer such that, in these embodiments, the seismic data processing computer 600 is not a part or does not have access to additional computing resources of a computer cluster, cloud computing system, etc.

The seismic data processor 602 (as used the disclosure, the term “processor” encompasses microprocessors) may include one or more processors having the capability to receive and process seismic data, such as data received from seismic receiving stations. In some embodiments, the seismic data processor 602 may include an application-specific integrated circuit (AISC). In some embodiments, the seismic data processor 602 may include a reduced instruction set (RISC) processor. Additionally, the seismic data processor 602 may include a single-core processors and multicore processors and may include graphics processors. Multiple processors may be employed to provide for parallel or sequential execution of one or more of the techniques described in the disclosure. The seismic data processor 602 may receive instructions and data from a memory (for example, memory 604).

The memory 604 (which may include one or more tangible non-transitory computer readable storage mediums) may include volatile memory, such as random access memory (RAM), and non-volatile memory, such as ROM, flash memory, a hard drive, any other suitable optical, magnetic, or solid-state storage medium, or a combination thereof. The memory 604 may be accessible by the seismic data processor 602. The memory 604 may store executable computer code. The executable computer code may include computer program instructions for implementing one or more techniques described in the disclosure. For example, the executable computer code may include seismic imaging instructions 612 that define a subsalt imaging tool 614 to implement embodiments of the present disclosure. In some embodiments, the seismic imaging instructions 612 may implement one or more elements of process 200 described above and illustrated in FIG. 2. In some embodiments, the seismic imaging instructions 612 may receive, as input, seismic data 610. As described herein, the subsalt imaging tool 614 may produce, as output a seismic image 616. The seismic image 616 may be stored in the memory 604 and, as shown in FIG. 6, may be displayed on the display 606.

The display 606 may include a cathode ray tube (CRT) display, liquid crystal display (LCD), an organic light emitting diode (OLED) display, or other suitable display. The display 606 may display a user interface (for example, a graphical user interface) that may display information received from the plant information processing computer 606. In accordance with some embodiments, the display 606 may be a touch screen and may include or be provided with touch sensitive elements through which a user may interact with the user interface. In some embodiments, the display 606 may display the seismic image 616 produced using the subsalt imaging tool 614 in accordance with the techniques described herein. For example, a seismic interpreter may view the seismic image 616 on the display 606 for improved interpretation of seismic imaging of a complex geographic structure, such as a structure having at least one subsalt layer.

The network interface 608 may provide for communication between the seismic data processing computer 600 and other devices. The network interface 608 may include a wired network interface card (NIC), a wireless (e.g., radio frequency) network interface card, or combination thereof. The network interface 608 may include circuitry for receiving and sending signals to and from communications networks, such as an antenna system, an RF transceiver, an amplifier, a tuner, an oscillator, a digital signal processor, and so forth. The network interface 608 may communicate with networks, such as the Internet, an intranet, a wide area network (WAN), a local area network (LAN), a metropolitan area network (MAN) or other networks. Communication over networks may use suitable standards, protocols, and technologies, such as Ethernet Bluetooth, Wireless Fidelity (Wi-Fi) (e.g., IEEE 802.11 standards), and other standards, protocols, and technologies. In some embodiments, for example, the unprocessed seismic data 6010 may be received over a network via the network interface 608. In some embodiments, for example, the seismic image 616 may be provided to other devices over the network via the network interface 608.

In some embodiments, seismic data processing computer may be coupled to an input device 620 (for example, one or more input devices). The input devices 620 may include, for example, a keyboard, a mouse, a microphone, or other input devices. In some embodiments, the input device 620 may enable interaction with a user interface displayed on the display 606. For example, in some embodiments, the input devices 620 may enable the entry of inputs that control the acquisition of seismic data, the processing of seismic data, and so on.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used described in the disclosure are for organizational purposes only and are not meant to be used to limit the scope of the description.

What is claimed is:

1. A method for producing a seismic image from seismic data generated from a plurality of seismic receiver stations configured to sense seismic signals originating from a plurality of seismic source stations, comprising:
obtaining the seismic data, the seismic data associated with a geological structure having a subsalt layer;
determining a transmitted wavefield from the stacked data of the seismic data;
iteratively updating a velocity model using the determined transmitted wavefield and a wave-equation tomography; and
producing a seismic image of the geological structure having the subsalt layer using the updated velocity model.

2. The method of claim 1, comprising processing the seismic data before determining a wavefield from the seismic image data.

3. The method of claim 1, wherein the geological structure comprises a seafloor.

4. The method of claim 1, comprising providing the seismic image to an interpreter.

5. The method of claim 1, wherein determining the transmitted wavefield from the seismic data comprises:
determining a Green's function from an analysis location to locations of the plurality of seismic receiver stations; and
shifting the Green's function by a time shift and convolving the shifted Green's function with a source function.

6. The method of claim 1, wherein iteratively updating the velocity model comprises inverting the determined transmitted wavefield using a traveltime inversion.

7. The method of claim 1, wherein iteratively updating the velocity model comprises using a steepest descent process to determine the updating.

8. A non-transitory computer-readable storage medium having executable code stored thereon for producing a seismic image from seismic data generated from a plurality of seismic receiver stations configured to sense seismic signals originating from a plurality of seismic source stations, the executable code comprising a set of instructions that causes a processor to perform operations comprising:
obtaining the seismic data, the seismic data associated with a geological structure having a subsalt layer;
determining a transmitted wavefield from the stacked data of the seismic data;
iteratively updating a velocity model using the determined transmitted wavefield and a wave-equation tomography performed on stacked data of the seismic data; and
producing a seismic image of the geological structure having the subsalt layer using the updated velocity model.

9. The non-transitory computer-readable storage medium of claim 8, comprising processing the seismic data before determining a wavefield from the seismic image data.

10. The non-transitory computer-readable storage medium of claim 8, wherein the geological structure comprises a seafloor.

11. The non-transitory computer-readable storage medium of claim 8, the operations comprising providing the seismic image to an interpreter.

12. The non-transitory computer-readable storage medium of claim 8, wherein determining the transmitted wavefield from the seismic data comprises:
determining a Green's function from an analysis location to locations of the plurality of seismic receiver stations; and
shifting the Green's function by a time shift and convolving the shifted Green's function with a source function.

13. The non-transitory computer-readable storage medium of claim 8, wherein iteratively updating the velocity model comprises inverting the determined transmitted wavefield using a traveltime inversion.

14. The non-transitory computer-readable storage medium of claim 8, wherein iteratively updating the velocity model comprises using a steepest descent process to determine the updating.

15. A system for producing for producing a seismic image from seismic data associated with a geological structure having a subsalt layer, the system comprising:
a plurality of seismic source stations;
a plurality of seismic receiver stations configured to sense seismic signals originating from the plurality of seismic source stations and generate the seismic data;
a seismic data processor;
a non-transitory computer-readable storage memory accessible by the seismic data processor and having executable code stored thereon for producing the seismic image from the seismic data, the executable code comprising a set of instructions that causes the seismic data processor to perform operations comprising:
obtaining the seismic data;
determining a transmitted wavefield from the stacked data of the seismic data;
iteratively updating a velocity model using the determined transmitted wavefield and a wave-equation tomography performed on stacked data of the seismic image data; and
producing a seismic image of the geological structure having the subsalt layer using the updated velocity model.

16. The system of claim 15, the operations comprising processing the seismic data before determining a wavefield from the seismic data.

17. The system of claim 15, the operations comprising providing the seismic image to an interpreter.

18. The system of claim 15, wherein determining the transmitted wavefield from the seismic data comprises:
determining a Green's function from an analysis location to locations of the plurality of seismic receiver stations; and
shifting the Green's function by a time shift and convolving the shifted Green's function with a source function.

19. The system of claim 15, wherein iteratively updating the velocity model comprises inverting the determined transmitted wavefield using a traveltime inversion.

20. The system of claim 15, wherein iteratively updating the velocity model comprises using a steepest descent process to determine the updating.
